(19) United States
(12) Patent Application Publication
(10) Pub. No.: US 2007/0089160 A1
(43) Pub. Date: Apr. 19, 2007

(54) Electronic device, video display device, and method of controlling the video display device

(75) Inventor: Morio Ando, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/524,932

(22) Filed: Sep. 22, 2006

(30) Foreign Application Priority Data
Sep. 28, 2005 (JP) 2005-281607

(51) Int. Cl. H04N 7/16

(52) U.S. Cl. 725/143

(57) ABSTRACT

According to one embodiment, a reception-side electronic device outputs reception specification data for receiving a signal suitable for the reception-side electronic device to a transmission-side device which selectively sends signals of the same contents in a plurality of signal forms. The reception-side electronic device includes transmitting/receiving and signal-processing units, a memory, a system setting unit, and a display processing unit which judges whether the first receiving specification data or the second receiving specification data is to be adopted as a signal to be transmitted to the transmission-side device.

### CROSS-REFERENCE TO RELATED APPLICATIONS

This application is based upon and claims the benefit of priority from Japanese Patent Application No. 2005-281607, filed Sep. 28, 2005, the entire contents of which are incorporated herein by reference.

### BACKGROUND

1. Field

One embodiment of the invention relates to an electronic device which receives a signal of, for example, video, voice or the like from a connected external device to process the signal, a video receiving device, and a method of controlling the video receiving device.

2. Description of the Related Art

As is well known, a digital visual interface (DVI) standard is prevailing as a standard for transmitting a digital video signal. Moreover, in recent years, a high definition multimedia interface (HDMI) standard has been adopted as a digital signal transmission standard obtained by further improving this DVI standard.

In this HDMI standard, there are incorporated various provisions which are not incorporated in the DVI standard, the provisions including: for example, a provision that a digital voice signal is multiplexed to a digital video signal blanking period and can be transmit voice; a provision that the digital video signal can be transmitted in the form of a YCbCr signal or a higher-definition YPbPr signal in addition to the form of an RGB signal; and a provision that the device can be connected by a universal serial bus (USB)-like small-sized HDMI connector.

In the HDMI standard, in a case where a signal of video or voice is transmitted from one electronic device to another electronic device, when a transmission-side electronic device acquires extended display identification (EDID) data from a reception-side electronic device, the signal can be output in a mode adapted to reception specifications of a display disposed in the reception-side electronic device.

In a case where the EDID data is transmitted from the reception-side electronic device, there is transmitted the EDID data indicating contents that data be requested in accordance with a capability of the reception-side display. When the transmission-side electronic device is changed, the EDID data is transmitted in accordance with a transmission capability on the transmission side. For example, in Jpn. Pat. Appln. KOKAI Publication No. 2004-102067, a system is disclosed in which a liquid crystal projector is disposed on the reception side and a personal computer (PC) or a set top box (STB) is disposed on the transmission side. Here, a plurality of types of EDID data adapted to the transmission-side device are stored beforehand in a nonvolatile memory, and any of the EDID data is transmitted to a connected device in accordance with the type of connected device.

In addition, in recent years, as a transmission-side connected device, there has been developed a video recording and reproducing device (e.g., a digital versatile disk (DVD) recording and reproducing device or a hard disk drive) having a function of outputting a standard (SD) signal and a function of outputting a high-definition (HD) signal. In a case where the signal is output to the outside, there is developed a device on which an HDMI transmitting and receiving unit is mounted in accordance with the HDMI standard. The above video recording and reproducing device also has a function of converting the SD signal into the HD signal to output the signal.

On the other hand, there is also developed a reception-side device such as a digital television reception device or a digital video treatment device on which the HDMI transmitting and receiving unit is mounted in accordance with the HDMI standard.

When the above transmission-side device is connected to the reception-side device via the HDMI connector, the following processing is usually performed during the transmission and reception of the EDID data. That is, the reception-side device transmits the EDID data via the HDMI connector. The EDID data declares that the reception-side device can handle even the HD signal. The transmission-side device transmits the HD signal as such, when a source signal is the HD signal. When the source signal is the SD signal, the transmission-side device converts up the SD signal into a pseudo HD signal to transmit the signal.

However, in recent years, the function of converting up the SD signal is also disposed on the reception side. In a case where the signal is converted up on the reception side, the quality is sometimes better than that in a case where the signal is converted up on the transmission side.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing one embodiment of this invention;

FIG. 2 is an exemplary block diagram showing an example of a menu screen and an example of a system setting screen in a device of this invention;

FIG. 3 is a flowchart showing an operation example in a case where a system is set in the device of this invention;

FIG. 4 is a flowchart showing an operation example in a case where the device of this invention transmits EDID data (receiving specification request data); and

FIG. 5 is a flowchart showing an operation example at a time when the EDID data is received in an optical disc reproduction device of FIG. 1.

### DETAILED DESCRIPTION

Various embodiments according to the invention will be described hereinafter with reference to the accompanying drawings. In general, according to one embodiment of the invention, an object of one embodiment of this invention is to provide an electronic device, a video receiving device and a method of controlling the devices in which an EDID signal of a form designated by a reception-side device can be sent so that the reception-side device can receive a convenient signal in a case where a transmission-side device performs transmitting signals of the same contents in a plurality of forms.

One embodiment of this invention provides a reception-side electronic device to output reception specification data of the reception-side electronic device to a transmission-side device which selectively sends signals of the same contents in a plurality of signal forms, the reception-side electronic device comprising: transmitting/receiving and signal-processing units which transmit the receiving specification data to the transmission-side device and which receive a signal sent in a predetermined standard from the transmission-side device to decode the signal into a video signal; a memory; a system setting unit which sets first receiving specification data to designate a signal form as a default as well as second receiving specification data to designate a desired signal form among the plurality of signal forms and which stores the data in the memory; and a display processing unit which judges whether the first receiving specification data or the second receiving specification data is to be adopted as a signal to be transmitted to the transmission-side device.

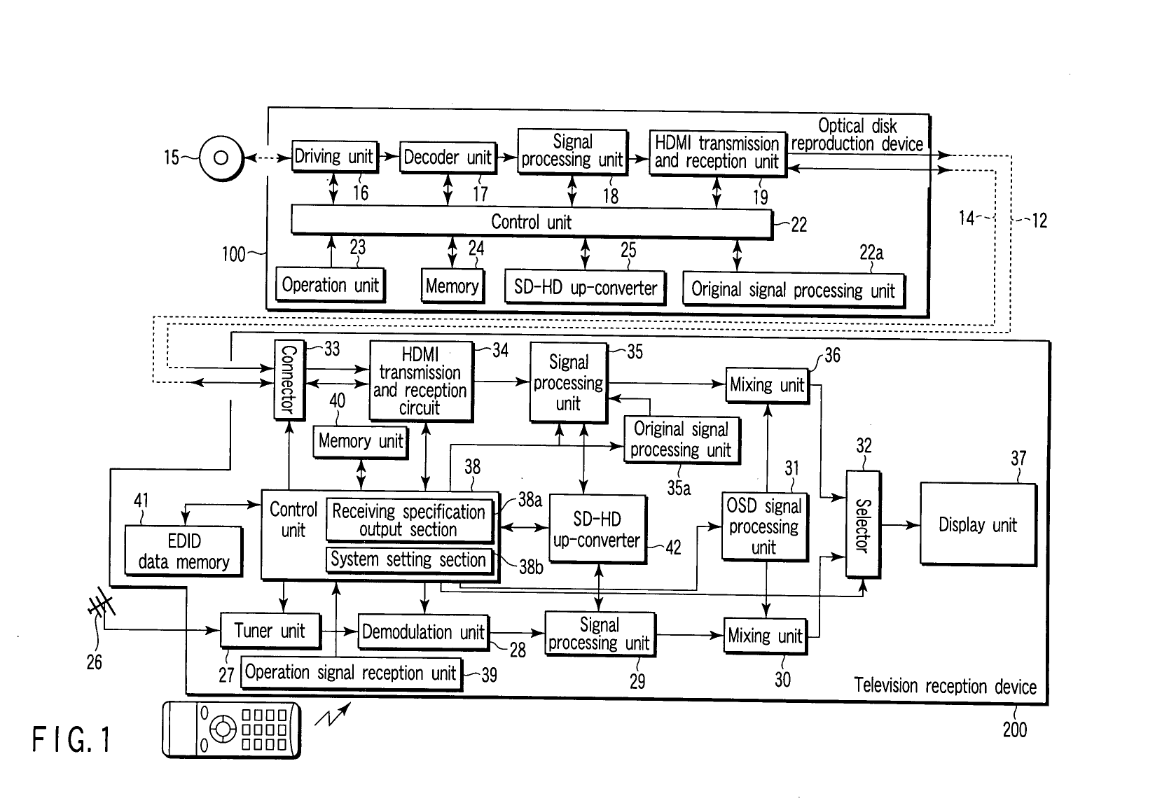

FIG. 1 shows a digital signal transmission system described in this embodiment. In FIG. 1, reference numeral 100 denotes an optical disk reproduction device which is a transmission-side electronic device.

This optical disk reproduction device 100 can convert a signal of video, voice or the like, obtained by reproducing an optical disc (or a hard disk), into a form which conforms to an HDMI standard, and the device can transmit the signal to a television reception device 200, which is a reception-side electronic device, via a transmission path 12.

This television reception device 200 has a function of receiving a television broadcasting signal to display video or reproduce voice, and has a function of displaying video or reproducing voice in response to a video or voice signal which is supplied via the transmission path 12 and which has a form in conformity to the HDMI standard.

Here, the television reception device 200 transmits EDID data to the optical disk reproduction device 100 via a transmission path 14 before the video or voice signal or the like is output to the television reception device 200.

In the television reception device 200, there are stored beforehand a plurality of pieces of EDID data indicating specifications (resolution, etc.) of a display of the television reception device, a display capability and a conversion capability. The television reception device 200 can select the EDID data designated and set by a user to transmit the data to the optical disk reproduction device 100 via the transmission path 14.

The optical disk reproduction device 100 can recognize display specifications of the television reception device 200 based on acquired EDID data, and output the video or voice signal or the like having the form adapted to the specifications to the television reception device 200 via the transmission path 12.

Here, in the television reception device 200, there are stored beforehand in a memory 41 or the like a plurality of types of EDID data prepared for a plurality of destinations, a receiving operation and the like. There are stored the EDID data indicating that an HD signal can be processed, an SD signal can be processed, an original signal can be processed and the like. However, the default EDID data is usually set, and the other types of EDID data can be set by the user as described later.

There will be described a signal processing system of the optical disk reproduction device 100. In the optical disk reproduction device 100, an optical disk 15 such as a digital versatile disk (DVD) is placed in a disk drive unit 16. When reproduction is requested, the disk drive unit reads requested recording data.

When the data read by the disk drive unit 16 is supplied to a decoder unit 17 and a signal processing unit 18, the data is successively subjected to digitization processing, error correction processing, decode processing and the like, and restored to digital video and voice signals.

The restored digital video and voice signals are supplied to an HDMI transmission and reception unit 19, converted into forms which conform to the HDMI standard, and guided to an electronic device (in this case, the television reception device 200) on a reception side via the transmission path 12.

The HDMI transmission and reception unit 19 can request the EDID data with respect to the reception-side electronic device (in this case, the television reception device 200) connected via the transmission path 14.

Furthermore, the HDMI transmission and reception unit 19 can acquire the EDID data output from the reception-side electronic device (in this case, the television reception device 200) connected via the transmission path 14.

In addition, an original signal processing unit 22a peculiar to a manufacturer or a maker may be built in the optical disk reproduction device 100. The original signal processing unit 22a contains, for example, commercial information associated with contents of the optical disk 15, commodity discount information, various types of control information and the like.

Here, all operations of the optical disk reproduction device 100, including the above reproducing operation, are generally controlled by a control unit 22. The control unit 22 contains a central processing unit (CPU) and the like, receives operating information sent from an operation unit 23 such as a remote controller, and controls each unit so that operation contents of the operating information are reflected.

In this case, the control unit 22 utilizes a memory unit 24. This memory unit 24 mainly has: a read only memory (ROM) in which a control program to be executed by the CPU is stored; a random access memory (RAM) which provides an operation area for the CPU; and a nonvolatile memory in which various types of setting information, control information and the like are stored.

Moreover, the control unit 22 recognizes display specifications of the reception-side electronic device (in this case, the television reception device 200) based on the EDID data acquired by the HDMI transmission and reception unit 19, and controls the signal processing unit 18 to generate the video or voice signal or the like having the form which is adapted to the specifications.

Furthermore, the optical disk reproduction device 100 has an SD-HD up-converter 25, and the SD signal can be converted up into the HD signal. To realize this, the optical disk reproduction device is basically set to send the up-converted HD signal in a case where the EDID data indicates that the reception-side device handles the HD signal.

Next, there will be described a signal processing system of the television reception device 200. A television broadcasting signal received by an antenna 26 is supplied to a tuner unit 27. The tuner unit 27 selects a desired broadcasting channel in response to the input television broadcasting signal to output a signal to the channel.

The television broadcasting signal output from the tuner unit 27 is subjected to predetermined modulation processing and signal processing by a demodulation unit 28 and a signal processing unit 29, respectively, and restored to an original television signal.

The television signal output from the signal processing unit 29 is mixed with an OSD signal output from an on-screen display (OSD) signal processing unit 31 by a mixing unit 30, and supplied to one input terminal of a selector 32.

On the other hand, the video or voice signal or the like supplied via the transmission path 12 is supplied to an HDMI transmission and reception circuit 34 via a connector 33. This HDMI transmission and reception circuit 34 subjects the input signal to processing to restore the signal to a pre-conversion signal, i.e., that before being converted by the HDMI transmission and reception unit 19 of the optical disk reproduction device 100. The restored signal is supplied to the other input terminal of the selector 32 via a signal processing unit 35 and a mixing unit 36.

Moreover, this television reception device 200 includes an SD-HD up-converter 42. Moreover, when the SD signal is input; the converter can convert up the SD signal into the HD signal to output the signal.

The selector 32 can selectively guide a signal supplied from the mixing unit 30 and a signal supplied from the mixing unit 36 into a display unit 37 to display video. It is to be noted that a voice component is used in reproducing voice by a speaker (not shown) or the like.

Furthermore, a request for acquiring the EDID data supplied via the transmission path 14 is supplied to the HDMI transmission and reception circuit 34 via the connector 33. The HDMI transmission and reception circuit 34 sends the EDID data indicating the display specifications of the device, stored in a memory 40 or the EDID data memory 41, in response to the input request under the control of a control unit 38 to allow the optical disk reproduction device 100 to acquire the data. It is to be noted that the memories 40 and 41 may be integrated with each other.

All operations of the television reception device 200, including the above series of operations, are controlled by the control unit 38. This control unit 38 contains a CPU and the like, and receives operating information from an operation signal reception unit 39 including a remote controller and the like, and controls each unit so that operation contents of the information are reflected.

In this case, the control unit 38 utilizes the memory unit 40. This memory unit 40 mainly has: a ROM in which a control program to be executed by the CPU is stored; a RAM which provides an operation area to the CPU; and a nonvolatile memory in which various types of setting information, control information and the like are stored.

Moreover, the television reception device 200 may be provided with an original signal processing unit 35a corresponding to the original signal processing unit 22a. When original-source reception specification data is transmitted to the optical disk reproduction device 100, original data is sent. The reception device can process sent original data by the original signal processing unit 35a. The original data is not set to a special standard, and can be processed in a system peculiar to the maker. Accordingly, the system can be distinguished from that of another maker.

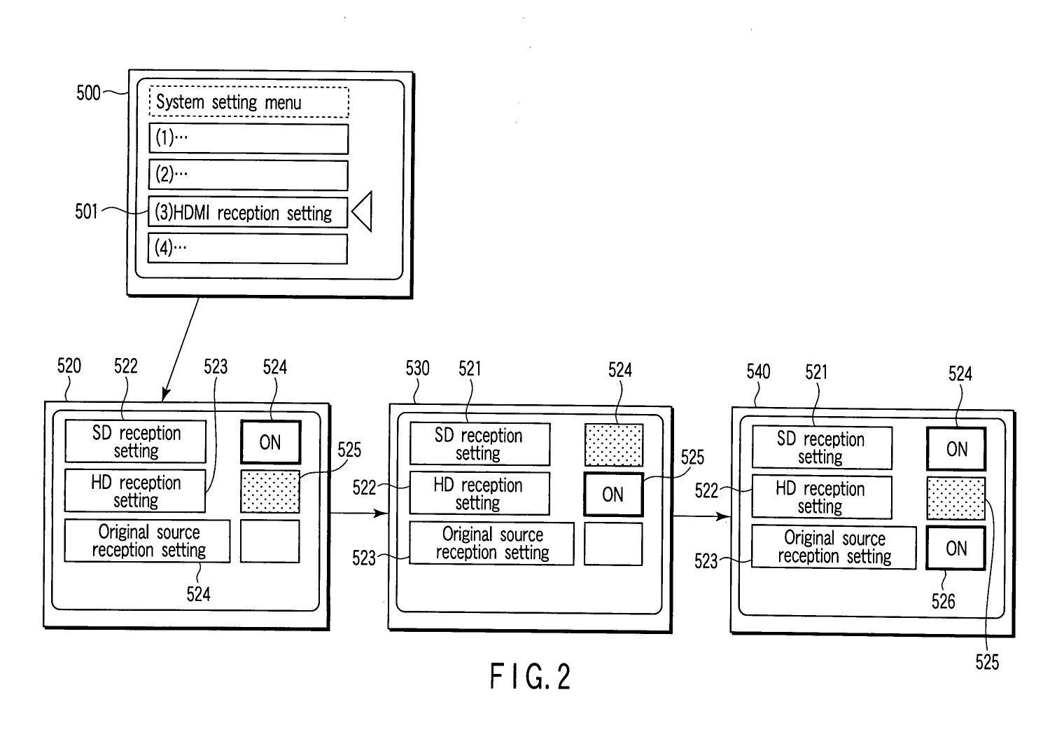

FIG. 2 shows a behavior of a screen in a case where the system is set in the television reception device 200. This television reception device 200 can request a transmission-side device (optical disk reproduction device 100 in this example) to send the SD signal by use of an HDMI transmission and reception system. That is, the optical disk reproduction device 100 has the SD-HD up-converter 25, but can reject the HD signal and request the SD signal. To realize this, the HDMI transmission and reception device needs to utilize a reception specification output section 38a and a system setting section 38b.

First, to start the system setting section 38b, a system setting menu screen is displayed. This is possible by operating a menu button of a remote controller 400.

A screen 500 of FIG. 2 is a menu screen for setting the system. In the screen, there is, for example, an “HDMI reception setting” item 501. When a cursor is positioned on this item 501, and a determine button is pushed, the screen changes to a screen 520. Here, in the screen 520, an “SD reception setting” item appears as an item 521, an “HD reception setting” item appears as an item 522, and an “original source reception setting” item appears as an item 523.

In this case, when the user aligns the cursor with the “SD reception setting” item to operate the determine button, a button adjoining the “SD reception setting” changes from a gray tone or a toned-down state to “ON”. A button adjoining the “HD reception setting” is displayed in gray or in the toned-down state. In this state, conversely, when the user aligns the cursor with the “HD reception setting” item to operate the determine button, the button adjoining the “HD reception setting” changes from the gray tone or the toned-down state to “ON” as shown in a screen 530. The button adjoining the “SD reception setting” is displayed in gray or in the toned-down state. Further in this state, when the user aligns the cursor with the “original source reception setting” item to operate the determine button, a button adjoining the “original source reception setting” changes to “ON” as shown in a screen 540. A button adjoining the “HD reception setting” is displayed in gray or in the toned-down state.

As described above, as the reception specifications indicated by the EDID data, this device has an HD signal processing capability with respect to a device to which the HD signal can be transmitted, but this device can request the SD signal. Usually in a case where the device has the HD signal processing capability, the EDID data indicating the HD signal reception specifications is transmitted to the transmission-side device, but in this invention, the SD signal can be requested. As described above in the paragraph of the object of this invention, in recent years, a function of converting up the SD signal has also been imparted to the reception side. The converting-up on the reception side sometimes assures a quality better than that of the converting-up on a transmission side.

It is to be noted that as the other reception specifications indicated by the EDID data, there are considered various specifications, such as a video graphics array (VGA), an extended graphics array (XGA) and UXGA, in a case where the electronic device is, for example, a personal computer (PC).

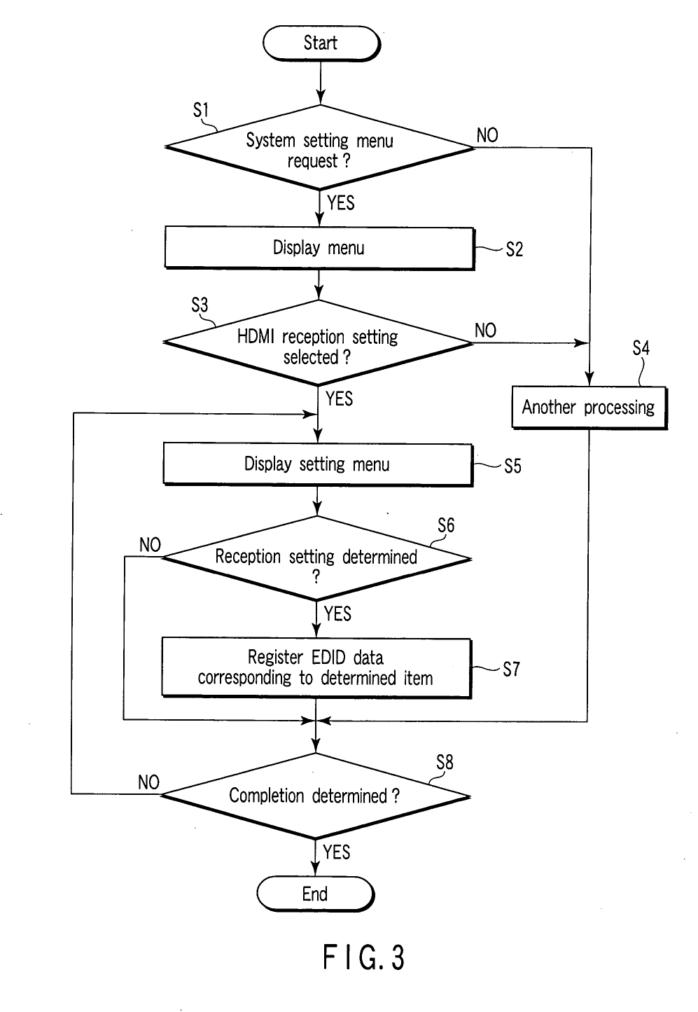

FIG. 3 shows an operation flow in a case where the system setting shown in FIG. 2 is performed in the television reception device 200. When there is a system setting menu request (step S1), a menu is displayed (step S2). The menu screen 500 is obtained as shown in FIG. 2. Next, when an HDMI reception setting is performed (step S3), the screen 520, 530 or 540 of FIG. 2 appears (S5). Subsequently, when the determine button is operated (step S6), the EDID data corresponding to the determined item is registered (step S6). The registering is performed by storing the EDID data in the memory 41. Finally, when a setting completion button is operated, the processing ends (step S8).

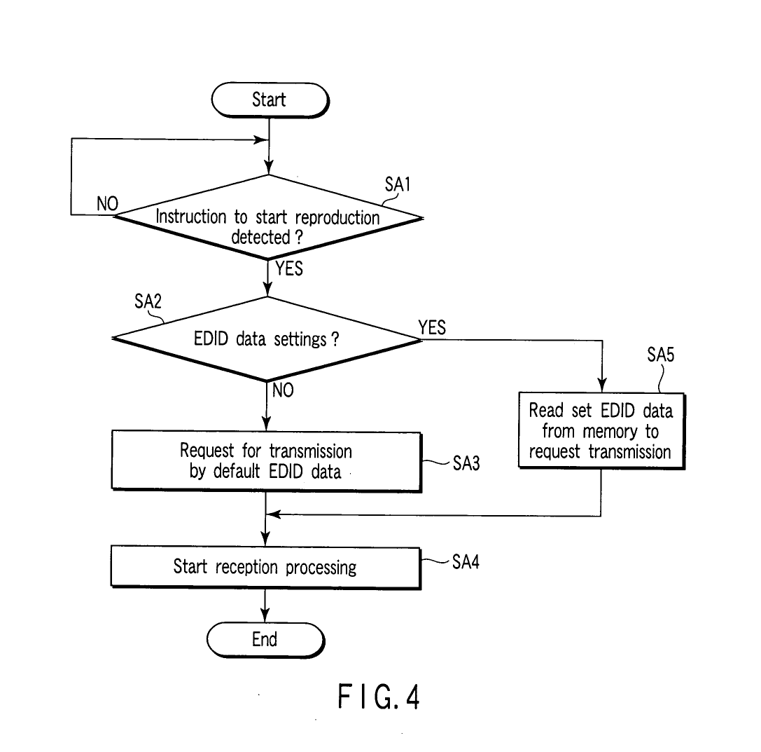

FIG. 4 shows processing of the television reception device 200 at a time when the optical disk reproduction device 100 is connected to the television reception device 200 as shown in FIG. 1, and a reproducing operation is performed.

When an instruction for starting reproduction is detected (step SA1), the reception specification output section 38a checks whether or not a plurality of pieces of EDID data are stored in the memory 41. Moreover, it is checked whether or not “ON” appears among the plurality of pieces of EDID data, resulting from pressing of the adjoining button, as described with reference to FIG. 2 (step SA2). If such data is not found, the default EDID data is output as a reception specification notifying signal (step SA3). Moreover, reception processing is started (step SA4). However, in a case where it is judged in the step SA2 that there is data requesting for the SD signal, a request for the SD signal is made (step SA5). Accordingly, the optical disk reproduction device 100 sends a signal of the HDMI standard in response to the reception specification notifying signal.

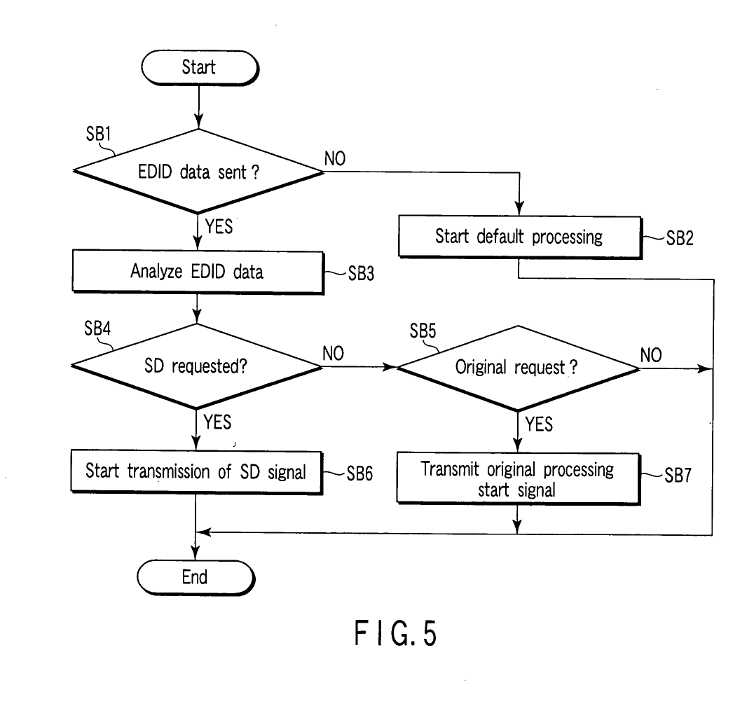

FIG. 5 is a flowchart showing an operation of the HDMI transmission and reception unit 19 on the side of the optical disk reproduction device 100. After giving an instruction for reproduction, it is checked whether or not the EDID has been sent (step SB1). When nothing is sent, default processing is started (step SB2). When the EDID data is sent, the data is analyzed (step SB3), and it is checked whether or not there is a request for the SD signal (step SB4). When there is a request for the SD signal, the SD signal reproduced in accordance with the HDMI specification is sent. When there is no request for the SD signal, it is checked whether or not there is a request for the original signal (step SB5). When there is a request for the original signal, processing of the original signal is started. When there is no request, a signal set to a default is basically sent.

Here, the processing of the original signal is, for example, processing to send special service data or a signal divided into chapters. Therefore, for example, to perform transmission and reception processing determined beforehand by the transmission-side and reception-side devices, the EDID data requesting the original signal becomes effective. Such function is effective, for example, in a case where the optical disk reproduction device 100 and the television reception device 200 are manufactured by the same maker, and there can be provided a service which cannot be obtained by a device manufactured by another maker.

It has been described above that the reception-side device is the television reception device. However, the HDMI transmission and reception circuit 34, the signal processing unit 35, the mixing unit 36 and the control unit 38 (especially, the reception specification output section 38a and the system setting section 38b ) are not limited to the television reception device, and they may be disposed in a set top box (STB), a server or the like.

According to the above means, even if the transmission side has a capability of sending an upgraded signal, processing can be performed to request for a lower-grade signal and convert the signal into the upgraded signal. That is, the device can receive a signal suitable for itself.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reception-side electronic device to output reception specification data to a transmission-side device which selectively sends signals of the same contents in a plurality of signal forms, the reception-side electronic device comprising:
transmitting/receiving and signal-processing units which transmit the receiving specification data to the transmission-side device and which receive a signal sent in a predetermined standard from the transmission-side device to decode the signal into a video signal;
a memory;
a system setting unit which sets first receiving specification data to designate a signal form as a default as well as second receiving specification data to designate a desired signal form among the plurality of signal forms and which stores the data in the memory; and
a display processing unit which is used to judge whether the first receiving specification data or the second receiving specification data is to be adopted as a signal to be transmitted to the transmission-side device.

2. The electronic device according to claim 1, wherein the receiving specification data is extended display identification (EDID) data defined by a high definition multimedia interface (HDMI) standard.

3. The electronic device according to claim 1, wherein the receiving specification data is extended display identification (EDID) data defined by a high definition multimedia interface (HDMI) standard, and the first receiving specification data and the second receiving specification data are data which designates a high-definition (HD) signal and data which designates a standard (SD) signal, respectively.

4. A video display device to output reception specification data to a transmission-side device which selectively sends signals of the same contents in a plurality of signal forms, the video display device comprising:
transmitting/receiving and signal-processing units which transmit the receiving specification data to the transmission-side device and which receive a signal sent in a predetermined standard from the transmission-side device to decode the signal into a video signal;
a memory;
a system setting unit which stores, in the memory, first receiving specification data which designates a signal form as a default as well as second receiving specification data which designates a desired signal form among the plurality of signal forms;
a display processing unit which is used to judge whether the first receiving specification data or the second receiving specification data is to be adopted as a signal to be transmitted to the transmission-side device; and
a conversion unit which converts, into another signal form, the signal of the desired signal form corresponding to the second receiving specification data, when the second receiving specification data is adopted, and sends the signal.

5. The video display device according to claim 4, wherein the receiving specification data is EDID data defined by an HDMI standard, and the first receiving specification data and the second receiving specification data are data which designates a high-definition (HD) signal and data which designates a standard (SD) signal, respectively.

6. The video display device according to claim 4, wherein the receiving specification data is EDID data defined by an HDMI standard,
the first receiving specification data and the second receiving specification data are data which designates a high-definition (HD) signal and data which designates a standard (SD) signal, respectively, and
the display processing unit displays a reception setting item of the HD signal and a reception setting item of the SD signal, respectively.

7. The video display device according to claim 4, wherein the receiving specification data is EDID data defined by an HDMI standard,
the first receiving specification data and the second receiving specification data are data which designates a high-definition (HD) signal and data which designates a standard (SD) signal, respectively, and
the display processing unit displays a reception setting item of the HD signal, a reception setting item of the SD signal and a reception setting item of an original source, respectively.

8. The video display device according to claim 4, wherein the receiving specification data is EDID data defined by an HDMI standard,
the first receiving specification data and the second receiving specification data are data which designates a high-definition (HD) signal and data which designates a standard (SD) signal, respectively,
the display processing unit displays a reception setting item of the HD signal and a reception setting item of the SD signal, respectively, and
the conversion unit is an SD-HD up-converter which converts the SD signal into the HD signal.

9. A method of controlling a control unit of a device having: transmitting/receiving and signal-processing units which transmit reception specification data to a transmission-side device to selectively send signals of the same contents in a plurality of signal forms and which receive a signal sent in a predetermined standard from the transmission-side device to decode the signal into a video signal; a memory; a display processing unit which outputs the video signal; and the control unit which controls an operation of a conversion unit to convert the signal form, the control unit controlling method comprising:
storing, in the memory, first receiving specification data which designates a signal form as a default as well as second receiving specification data which designates a desired signal form among the plurality of signal forms;
performing such display as to judge whether the first receiving specification data or the second receiving specification data is to be adopted as a signal to be transmitted to the transmission-side device; and
converting, into another signal form, the signal of the desired signal form corresponding to the second receiving specification data, when the second receiving specification data is adopted, and sending the signal.

10. The method of controlling the video display device according to claim 9, wherein the receiving specification data is EDID data defined by an HDMI standard, and the first receiving specification data and the second receiving specification data are data which designates a high-definition (HD) signal and data which designates a standard (SD) signal, respectively,
the method comprising: converting the standard (SD) signal into the high-definition (HD) signal, when the standard (SD) signal corresponding to the second receiving specification data is sent.
